(19) United States
(12) Patent Application Publication
(10) Pub. No.: US 2026/0272610 A1
(43) Pub. Date: Sep. 17, 2026

(54) Automated Process for Intermediate Orthodontic Digital Setup Generation

(71) Applicant: Solventum Intellectual Properties Company, Eagan, MN (US)

(72) Inventors: Alexandra R. Cunliffe, Saint Paul, MN (US); Benjamin D. Zimmer, Hudson, WI (US); Jonathan D. Gandrud, Woodbury, MN (US); Guruprasad Somasundaram, Plymouth, MN (US); Arash Sangari, Frisco, TX (US); Deepti Pachauri, Minneapolis, MN (US); Shawna L. Thomas, College Station, TX (US); Nancy M. Amato, Champaign, IL (US)

(21) Appl. No.: 19/668,604

(22) Filed: May 5, 2026

Related U.S. Application Data
(63) Continuation of application No. 16/652,755, filed on Sep. 27, 2018, now Pat. No. 12,642,623.
(60) Provisional application No. 62/569,081, filed on Oct. 6, 2017.

(51) Int. Cl. A61C 7/00; A61C 9/00

(52) U.S. Cl. CPC A61C 7/002; A61C 9/0053

(57) ABSTRACT

A method for generating digital setups for an orthodontic treatment path. The method includes receiving a digital 3D model of teeth, performing interproximal reduction (IPR) on the model and, after performing the IPR, generating an initial treatment path with stages including an initial setup, a final setup, and a plurality of intermediate setups. The method also includes computing IPR accessibility for each tooth at each stage of the initial treatment path, applying IPR throughout the initial treatment path based upon the computed IPR accessibility, and dividing the initial treatment path into steps of feasible motion of the teeth resulting in a final treatment path with setups corresponding with the steps. The setups can be used to make orthodontic appliances, such as clear tray aligners, for each stage of the treatment path.

### BACKGROUND

Intermediate staging of teeth from a malocclusion stage to a final stage requires determining accurate individual teeth motions in a way that teeth are not colliding with each other, the teeth move toward their final state, and the teeth follow an optimal (preferably short) trajectories. Since each tooth has 6 degrees-of-freedom and an average arch has about 14 teeth, finding the optimal teeth trajectory from initial to final stage has a large and complex search space. A need exists to simplify this optimization problem by dividing the trajectory to several shorter and easier to find trajectories, and by using other methods and techniques.

### SUMMARY

A method for generating setups for an orthodontic treatment path, consistent with the present invention, includes receiving a digital 3D model of teeth, optionally performing IPR on the model and, after performing the optional IPR, generating an initial treatment path with stages including an initial setup, a final setup, and a plurality of intermediate setups. The method also includes computing IPR accessibility for each tooth at each stage of the initial treatment path, applying IPR throughout the initial treatment path based upon the computed IPR accessibility, and dividing the initial treatment path into steps of feasible motion of the teeth resulting in a final treatment path with setups corresponding with the steps.

Another method for generating setups for an orthodontic treatment path, consistent with the present invention, includes receiving a first digital model of teeth representing a first state, receiving a second digital model of teeth representing a second state, and dividing between the first and second states a set of states corresponding to feasible motion steps from the first state to the second state.

### BRIEF DESCRIPTION OF THE DRAWINGS

The accompanying drawings are incorporated in and constitute a part of this specification and, together with the description, explain the advantages and principles of the invention. In the drawings,

FIG. 1 is a diagram of a system for generating digital setups for orthodontic appliances;

FIG. 2 is a flow chart of a method for generating digital setups for orthodontic appliances;

FIG. 3 is a graph illustrating an initial sequence of digital setups;

FIGS. 4A-4D are graphs illustrating trajectory refinement for a sequence of digital setups;

FIGS. 5A and 5B are diagrams illustrating accessible and inaccessible contacts for IPR application;

FIGS. 6A and 6B are diagrams illustrating IPR regions for accessible contact points;

FIG. 7 is a diagram illustrating an IPR region for accessible contact points; and

FIG. 8 is a graph of an accessibility matrix for IPR.

### DETAILED DESCRIPTION

Embodiments of this invention include a possibly partially to fully automated system to generate a set of intermediate orthodontic setups that allow a set of teeth to move from the maloccluded to the final setup state or allow for a partial treatment from one state to another state (e.g., an initial state to a particular intermediate state). Each arrangement of teeth (“state” or “setup”) is represented as a node in a graph, and robotic motion planning is used to expand the graph and search for a path of valid states. These states or setups can be a digital representation of the arrangement of teeth at a particular stage of treatment, where the representation is a digital 3D model. The digital setups can be used, for example, to make orthodontic appliances such as clear tray aligners to move teeth along a treatment path. The clear tray aligners can be made by, for example, converting the digital setup into a corresponding physical model and thermoforming a sheet of material over the physical model or by 3D printing the aligner from the digital setup. Other orthodontic appliances, such as brackets and archwires, can also be configured based upon the digital setups.

The system and method can take into consideration interproximal reduction (IPR), which is the removal of some of the outer tooth surface, called enamel. IPR is also known as, and the term IPR includes, slenderizing, stripping, enamel reduction, reproximation, and selective reduction. IPR can be used, for example, between teeth that touch in order to make room to move teeth in orthodontic procedures. The system and method apply IPR to a digital 3D model of teeth to simulate application of IPR to actual teeth represented by the model. In other embodiments, the system and method do not require consideration of IPR. In other embodiments, the system and method can model the opposite of IPR using the same or similar techniques, for example as applied to bridges or implants.

In one embodiment, the method: 1) performs IPR up-front on a digital 3D model of teeth and generates an initial treatment path with digital setups; 2) computes IPR accessibility for each tooth at each stage of the initial treatment path and possibly determines when to apply IPR; and 3) applies IPR throughout the treatment path and divides the treatment path into steps of biologically feasible motion, a trajectory with points for the digital setups to make appliances corresponding with each setup. In other embodiments, the method can proceed without IPR or with IPR when possible to perform IPR.

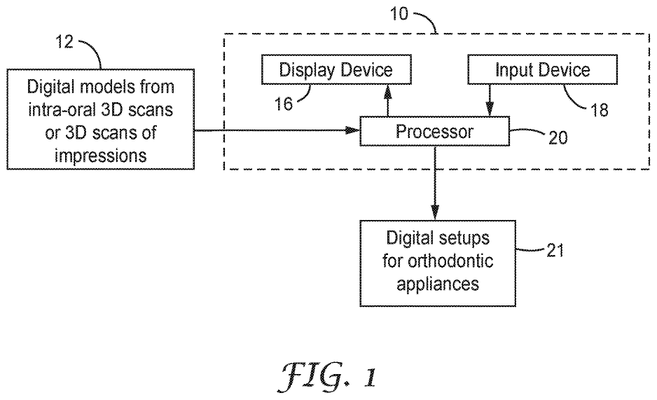

FIG. 1 is a diagram of a system 10 for generating digital setups for orthodontic appliances (21). System 10 includes a processor 20 receiving digital 3D models of teeth (12) from intra-oral 3D scans or scans of impressions of teeth, or in other embodiments the system receives user manual input. System 10 can also include an electronic display device 16, such as a liquid crystal display (LCD) device, and an input device 18 for receiving user commands or other information. Systems to generate digital 3D images or models based upon image sets from multiple views are disclosed in U.S. Pat. Nos. 7,956,862 and 7,605,817, both of which are incorporated herein by reference as if fully set forth. These systems can use an intra-oral scanner to obtain digital images from multiple views of teeth or other intra-oral structures, and those digital images are processed to generate a digital 3D model representing the scanned teeth and gingiva. System 10 can be implemented with, for example, a desktop, notebook, or tablet computer. System 10 can receive the 3D scans locally or remotely via a network.

The 3D scans addressed herein are represented as triangular meshes. The triangular mesh is a common representation of 3D surfaces and has two components. The first component, referred to as the vertices of the mesh, are simply the coordinates of the 3D points that have been reconstructed on the surface—i.e., a point cloud. The second component, the mesh faces, encodes the connections between points on the object and is an efficient way of interpolating between the discrete sample points on the continuous surface. Each face is a triangle defined by three vertices, resulting in a surface that can be represented as a set of small triangular planar patches.

### A. Algorithm Overview

Embodiments include a motion planning-based approach to generate intermediate setups (staging) given an initial maloccluded setup and a final proposed setup. The goal is to produce a series of setups that bring the maloccluded setup into the final proposed setup that also meet some evaluation criteria while satisfying per-stage tooth movement limits. Evaluation criteria may require collision-free setups, minimal gingiva displacement, permitted motion, how motion can be related, or other conditions.

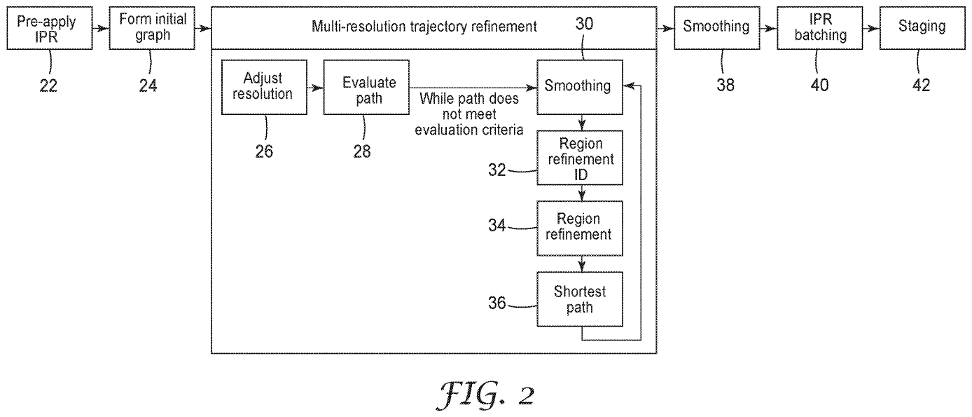

The flow chart shown in FIG. 2 provides an overview of the system and method. A sequence of key setups is provided as input, where the first is the maloccluded state, the last is the final proposed setup, and the others are additional setups (“key setups”) that will help guide the motion. Key setups are a way to guide the search for intermediate setups, but key setups are not required for intermediates. For example with key setups, when creating space to reduce the crowding of teeth, trajectories often should move and tip the teeth outward, apply IPR, and then retract/upright the teeth. In this case, one key setup could be added in addition to the first and last that specifies this flared-out configuration. Intermediate key setups may be generated manually by a technician or through an automated approach. One potential method for intermediate key setup generation is to encode a rule for coordinated tooth motion (e.g., flare out) that can be applied to a set of teeth. Another possible method uses a logic controller to create key intermediate setups based upon inputs, outputs, and rules as specified below.

The inputs variables of this logic controller are:
The difference between the current and the target position (i.e. position error vector) for each tooth (eₓ, e_{y}, e_{z}),
The Euler angles error vector for each tooth (e_{φ}, e_{θ}, e_{ψ}),
The penetration depth for tooth collision (Pd), and
The direction of a possible penetration for tooth collision (cₓ, c_{y}, c_{z}).
   The output variables or the control commands of this logic controller are:
The Euler angles vector of the rotation command for each tooth (dₓ, d_{y}, d_{z}), and
The translation vector command for each tooth (d_{φ}, d_{θ}, d_{ψ}).
   In one embodiment, there are two sets of control rules that govern the key frame generation system: to control each tooth to converge to the tooth's final state or an intermediate state (Table 1), and to avoid collisions by moving in the opposite direction of the penetration depth (Table 2).

TABLE 1
A subset of rules that are applied to move a tooth along the
x-axis when the tooth is free to move (i.e. moving toward the
target position will not increase the penetration depth)

IF ( (Pd is ZERO) OR (cₓ is ZERO) OR (cₓ is NEGATIVE) ) AND (eₓ is POSITIVE)

THEN dₓ is POSITIVE.

IF ( (Pd is ZERO) OR (cₓ is ZERO) OR (cₓ is POSITIVE) ) AND (eₓ is NEGATIVE)

THEN dₓ is NEGATIVE.

IF ( (Pd is ZERO) OR (cₓ is ZERO) ) AND (eₓ is ZERO)

THEN dₓ is ZERO.

...

TABLE 2
A subset of rules that are applied to move a tooth along the
x-axis when the tooth is not free to move (i.e. moving toward
the target position will increase the penetration depth).

IF (Pd is SMALL) AND (cₓ is POSITIVE) AND (eₓ is POSITIVE) THEN dₓ is ZERO.
IF (Pd is LARGE) AND (cₓ is POSITIVE) AND (eₓ is POSITIVE) THEN dₓ is NEGATIVE.
IF (Pd is SMALL) AND (cₓ is POSITIVE) AND (eₓ is ZERO) THEN dₓ is ZERO.
IF (Pd is LARGE) AND (cₓ is POSITIVE) AND (eₓ is ZERO) THEN dₓ is NEGATIVE.
IF (Pd is SMALL) AND (cₓ is NEGATIVE) AND (eₓ is ZERO) THEN dₓ is ZERO.
IF (Pd is LARGE) AND (cₓ is NEGATIVE) AND (eₓ is ZERO) THEN dₓ is POSITIVE.
IF (Pd is SMALL) AND (cₓ is NEGATIVE) AND (eₓ is NEGATIVE) THEN dₓ is ZERO.
IF (Pd is LARGE) AND (cₓ is NEGATIVE) AND (eₓ is NEGATIVE) THEN dₓ is
POSITIVE.
...

All IPR is pre-applied to the maloccluded state (step 22). This means that the total IPR prescribed to be performed by the end of treatment is applied to the geometry that will be used throughout the region refinement step. After IPR is applied, a graph is formed including the key setups, S₁, S₂, S₃, and S₄ (step 24) as shown in FIG. 3, where S₁ is the initial maloccluded state, S₄ is the final setup at the end of treatment, and S₂ and S₃ are intermediate setups at different stages of treatment. Once a sequence of states has been created, multi-resolution trajectory refinement is performed (steps 26, 28, 30, 32, 34, and 36 explained below).

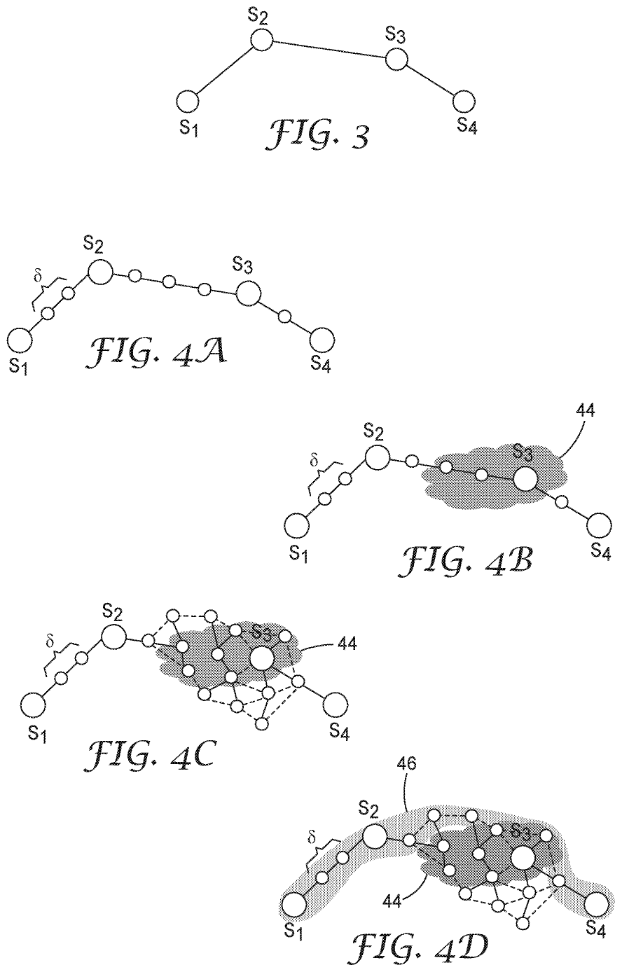

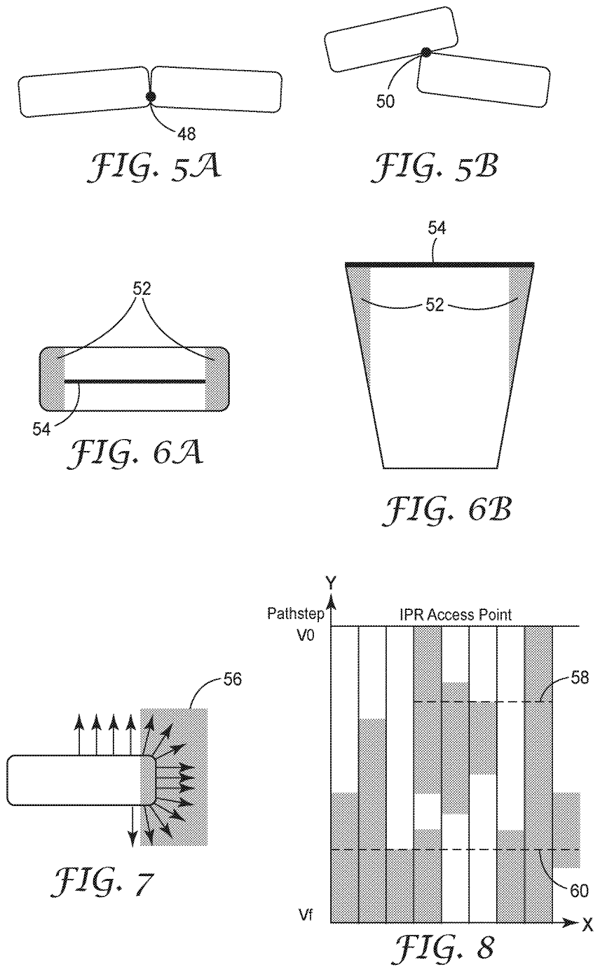

This trajectory refinement process is described for a single resolution in FIGS. 4A-4D. First, the shortest path through the graph is linearly interpolated at a resolution δ (FIG. 4A), where δ changes at each resolution in the multi-resolution approach. Once interpolated, each setup in the sequence is evaluated to see if the setup meets the given criteria (FIG. 4B). If the evaluation criteria are not met, the refinement process repeats until the shortest path meets the criteria. Invalid states are targeted for refinement (the setup in region 44 in FIG. 4C), and a search commences from these states and their neighbors. Here the search is at the same resolution δ for the linear interpolation. Additional edges are generated during the search (the dashed lines in FIGS. 4C and 4D) to allow for multiple paths in the graph between the initial and final setups. Edges are weighted by the node that they proceed from. After many new edges are added, a search is

Algorithm 2 AdjustResolution(G, P, δ)

Input: A graph G.
Input: A path P ∈ G.
Input: A stepsize δ.
Output: A new path P′ that follows P at resolution δ. G is also updated to
resolution δ along P.

| | |
|---|---|
| 1: | P′ ← p₁. |
| 2: | for p₁ ∈ p₂ ... pₙ do |

| | |
|---|---|
| 3: | I ← Interpolate(pᵢ₋₁, pᵢ, δ). |
| 4: | Append I to P′. |
| 5: | Remove the edge (pᵢ₋₁, pᵢ) from G. Add I to G with its corresponding edges. |

| | |
|---|---|
| 6: | end for |
| 7: | return P′. |

This algorithm 2 uses an interpolate subroutine with two options: same finish where all teeth complete their motion at the same (last) stage; and fast finish where teeth complete their motion as fast as possible and may not all finish at the same stage. The preferred mode uses same finish.

B2b. Refinement Region Identification (32)

This identifies a subset of the trajectory P that needs further refinement according to some evaluation criteria E. Some options for the output of this algorithm could include returning all portions of P that violate E, or the first offender in P, or the worst offender in P. The following approaches are possible implementations for this refinement:
IdRefinementRegionFirst: Returns the first location along P where the score computed using the evaluation criteria exceeds a threshold score.
IdRefinementRegionAll: Returns all locations along P where the score computed using the evaluation criteria exceeds a threshold score.
IdRefinementRegionWorst: Returns the worst offender in P, defined as the element that received the worst score using the evaluation criteria. In the case of a tie (i.e., multiple worst offenders), the last worst offender in P is returned.
IdRefinementRegionWorstAll: Returns all worst offenders in P.
IdRefinementRegionWorstNeighbors: Returns the worst offender in P and its N neighbors in P. In the case of a tie (i.e., multiple worst offenders), the last worst offender in P is returned.
   The preferred mode of the system uses IdRefinementRegionAll.

Refinement region identification uses an evaluation criterion that is defined by an evaluator subroutine. Other scoring criteria, such as tooth displacement from gingiva or number of collision points as the evaluator, considering only nodes with 0 collision points to be valid.

The preferred mode for the Smooth function is the iterative smoother described in “B2d. Trajectory smoothing” below.

B2d. Trajectory Smoothing (30, 38)

There are many possible smoothing algorithms. One possibility (Algorithm 5) attempts all possible edges between any two nodes in P, only retaining those that meet E at resolution δ. However, this approach is computationally expensive, especially for long paths. Instead, smoothing can be attempted only for nodes that are within a distance threshold of each other. Another implementation includes an iterative smoother that applies this smoothing process repeatedly until a score is no longer improved through smoothing. This iterative smoother is the preferred mode.

Algorithm 5 Smooth(P, E, δ)

Input: A sequence of setups P from p₀ to pₙ.
Input: An evaluation function E that assigns scores to setups.
Input: A stepsize δ.
Output: A smoothed trajectory P′ at resolution δ.

| | |
|---|---|
| 1: | Construct a graph G from the vertices and edges given by P. |
| 2: | for all pᵢ ∈ P do |

| | |
|---|---|
| 3: | for all pⱼ ≠ pᵢ ∈ P do |

| | |
|---|---|
| 4: | Pᵢⱼ ← Interpolate(pᵢ, pⱼ, δ). |
| 5: | if Pᵢⱼ meets E then |

| | |
|---|---|
| 6: | Add Pᵢⱼ to G. |

| | |
|---|---|
| 7: | end if |

| | |
|---|---|
| 8: | end for |

| | |
|---|---|
| 9: | end for |
| 10: | return ShortestPath(G, p₀, pₙ). |

### b3. IPR Batching (40)

Because IPR was pre-applied (Section B1), automated intermediate trajectory finding is performed initially with all IPR performed up front when teeth are in the maloccluded state. However, it is often impossible or not practical to do this in practice, as teeth need to be accessible in order to perform IPR and may not become accessible until a later point during treatment. This section provides a strategy for incorporating IPR batching into planning. The method takes as input the graph and path generated by the algorithm when IPR is applied up front (the output from Section 2). This path is then refined based on IPR application.

A contact point is in the IPR region 52 if it lies nears the incisal endpoints 54, as shown in FIGS. 6A and 6B.

By Contact Point Outward Normal Orientation. The algorithm can also define the mesial/distal region as the area where outward normals are approximately oriented along the arch form (see the shaded region 56 of FIG. 7). IPR accessibility is determined by comparing the outward contact point normal to the local tooth x-axis.

Hybrid Approach. A hybrid approach combines the approaches presented above. If one approach is indeterminate, then the other approach can be used.

B3b. IPR Application

Once there is a model for determining if IPR is accessible, that model can be used to decide when IPR is possible. This allows for relaxing the assumption that IPR is always immediately applied. RefineTrajectoryWithIPR is similar the trajectory refinement approach presented in Section B2 when only a single resolution level is used.

Algorithm 1 RefineTrajectoryWithIPR(v₀, v_{f}, G, δ, l, E)

Input: The initial and final setups v₀ and v_{f}, Typically, v₀ is the maloccluded setup and v_{f} is the final

proposed setup. v₀ may not have IPR applied yet.

Input: A graph G containing vertices v₀ and v_{f}, v₀ and v_{f} are connected in G and the shortest path

between them is the result of a prior trajectory refinement where IPR was applied at the beginning.

Input: A stepsize δ.
Input: A staging limit l.
Input: An evaluation function E that assigns scores to setups.
Output: A staged trajectory at resolution l that starts at v₀, ends at v_{f}, IPR applied when accessible, and

| | |
|---|---|
| | minimizes undesirable motions. |
| 1: | for all v ≠ v_{f} ∈ G do |

| | |
|---|---|
| 2: | Reset IPR degrees of freedom to 0 (e.g., none applied). |

| | |
|---|---|
| 3: | end for |
| 4: | P ← ShortestPath(G, v₀, v_{f}). |
| 5: | P ← AdjustResolution(G, P, δ). |
| 6: | ApplyIPR(P, G). |
| 7: | while P does not meet E do |

| | |
|---|---|
| 8: | P ← Smooth(P, E, δ). |
| 9: | R ← IdentityRefinementRegion(P, E). |
| 10: | RefineRegion(G, v₀, v_{f}, R). |
| 11: | P ← ShortestPath(G, v₀, v_{f}). |

| | |
|---|---|
| 12: | end while |
| 13: | P ← Smooth(P, E, δ). |
| 14: | return Stage(P, l). |

First, all applied IPR is reset back to 0, except for v_{f}. Then IPR is applied to P according to an IPR strategy (see Section B3c: IPR Strategy). Refinement proceeds as before to remove any remaining invalid portions of the trajectory.

The ApplyIPR subroutine examines the path P, applying IPR up to the limits given in v_{f} only when accessible and based on an application policy. (IPRisAccessible in Algorithms 2 and 3 implements the desired access model from Section B3a. IPR Accessibility). When IPR is applied to a particular vertex, it is propagated to all of its children (i.e., IPR values only increase along the trajectory, meaning tooth material is not added back).

B3c. IPR Strategy

The following are two possible IPR batching policies: as soon as possible and batching to minimize the number of IPR sessions.

As soon as possible. Algorithm 2 below simply iterates through P, applying the full IPR value from vs to neighboring pairs of teeth that do not have the full value yet applied and are accessible as reported by IPRisAccessible (see Section B3a. IPR Accessibility).

Algorithm 2 ApplyIPR(P, G)

Input: A path P from v₀ to v_{f} in G.
Output: An updated path P and graph G with IPR applied as soon as possible.

| | |
|---|---|
| 1: | v ← v₀. |
| 2: | while v ≠ v_{f} do |

| | |
|---|---|
| 3: | for each neighboring pair of teeth (t₁, t₂) ∈ v do |

| | |
|---|---|
| 4: | if IPR present between t₁ and t₂ at v < IPR present between t₁ and t₂ at v_{f} then |

| | |
|---|---|
| 5: | If IPRisAccessible(t₁,t₂) then |

| | |
|---|---|
| 6: | Apply IPR to t₁ and t₂ with values from v_{f}. |
| 7: | Propagate IPR all children of v in P and G regardless of future accessibility and excluding v_{f} |
| | (as to not override final values with a partial application). |

| | |
|---|---|
| 8: | end if |

| | |
|---|---|
| 9: | end if |

| | |
|---|---|
| 10: | end for |
| 11: | v ← successor of v along P. |

| | |
|---|---|
| 12: | end while |
| 13: | return (P, G). |

Batching to minimize number of IPR sessions. IPR batching can be considered as an optimization problem where one wants to minimize the number of times that IPR is applied. Thus, IPR should be fully applied when accessible. There is also a preference for applying IPR as early in treatment as possible.

To optimize for batching, the algorithm can examine when every IPR application point is accessible along P. The algorithm can use an accessibility matrix for this feature (FIG. 8). IPR application points lie along the x-axis in the matrix. Note that teeth that do not need any IPR applied (e.g., molars or teeth with the same IPR in v₀ as in v_{f}) are excluded from this matrix as they are not actionable IPR application points. The y-axis represents the path steps along P, going from v₀ to v_{f}. Each cell is shaded if that IPR application point is accessible at that path step (determined using IPRisAccessible from Section B6a). A horizontal cut, represented by lines 58 and 60, along this matrix represents applying IPR to the shaded set of teeth collectively. Thus, the algorithm seeks to minimize the number of cuts required to cover all IPR application points. For a given cut, IPR is applied at the first path step where the maximum number of teeth are accessible.

Algorithm 3 below outlines how this accessibility matrix may be used to apply batched IPR. In Algorithm 3, IPRisAccessible is not explicitly called before applying IPR, as it is implied in the construction of the accessibility matrix A.

Algorithm 3 ApplyIPR(P, G)

Input: A path P from v₀ to v_{f} in G.
Output: An updated path P and graph G with IPR applied as soon as possible.

| 1: | Construct o \|P\| × n accessibility matrix A, where n is the number of teeth pairs (i.e., IPR application |
|---|---|
| | points). |
| 2: | Minimize the number of slices through A that cover all IPR application points. Let S contain these |
| | slices. |
| 3: | for each s ∈ S do |

| | |
|---|---|
| 4: | for each neighboring pair of teeth (t₁,t₂) ∈ s do |

| | |
|---|---|
| 5: | Apply IPR to t₁ and t₂ with values from v_{f}. |
| 6: | Propagate IPR all children of v in P and G regardless of future accessibility and |

excluding v_{f} (as to not override final values with a partial application).

| | |
|---|---|
| 7: | end for |

| | |
|---|---|
| 8: | end for |
| 9: | return (P, G) |

The key step is the minimization function for finding the slices S. To do this, the algorithm adds slices to S starting with the slice that maximizes the number of remaining application points affected.

### B4. Trajectory Staging (42)

The objective of trajectory staging is to create a path P at a resolution l, which is defined based on per-stage tooth movement limits. Pseudo-code for this approach is shown below:
1. P_staged=P[0]
2. Compute Δd, the change in tooth position from maloccluded state for each node in P
3. For each Δd:
   a. If Δd>per-stage tooth movement limits:
   b. Append P[i−1] (the node immediately prior to the current node) to P_staged
   c. Recompute Δd as the change in tooth position from P[i−1]
4. Append the setup state (P[end]) to P_staged
   In the system, trajectory staging need not but could be used. Instead, the resolution that the system uses to interpolate the path is equal to the per-stage tooth movement limits.

### C. Additional Components and Capabilities

### C1. Multiple Path Extraction

This component enables a set of valid paths to be presented to a practitioner, enabling the practitioner or patient to select the desired treatment path. To benefit the technician or practitioner, multiple path choices should be dissimilar. In particular, they should all be viable but have different high-level properties such as number of IPR stages, amount of round-tripping, or other options. To provide this, paths should be scored or annotated based on such properties. Then the algorithm would identify all viable paths, sort them by score, and report back the best scoring paths that do not share the same properties as other, better-scoring, paths in the list.

### C2. Multiple IPR Policies

This component would offer practitioners a choice of what IPR application policy to apply: as soon as possible, batching to minimize the number of treatments, or a policy in between. Options can be provided to the practitioner, who would then evaluate different options on a case by case basis if desired or if their preferred policy yields less than desirable results.

C3. Single vs. Multiple Arch

In one implementation, upper and lower arches are considered separately because it is an easier (and thus faster) problem to solve. In another embodiment, both arches are supported and considered together in the case that this is preferred, for example.

### C4. Interactive Tools

Several of the library components can either be fully specified by the user, fully automated, or interactive, where the user provides inputs to the automatic method. This spectrum can be seen in the following areas.

Key Setup Generation—This can be one of the most difficult steps to automate yet the user may be able to provide inputs to the method. Selecting useful key setups could rely on the ability to classify what case type one is considering (crowding, midline correction, etc.). This is something that may be learned over time by an algorithm but is easy for a technician to provide (via quick visual inspection and an input such as a checkbox). In addition, a technician could also explicitly provide intermediate stages that characterize the corrective treatment plan for the case type.

Perturbation Motions—To a lesser degree than above, a technician may also be able to provide corrective motion planning possibly through approximate setup input. This planning can then be applied during automated perturbation of invalid states, enabling a clinically valid solution to be discovered more quickly.

Identification of Refinement Regions—If the algorithm is focused on some local minima, a user may be able to identify good regions for refinement based on visual inspection and manually perturb the state towards these good regions.

1.-28. (canceled)

29. A computer-implemented method for generating orthodontic intermediate digital setups, the method comprising:
receiving an initial digital three-dimensional (3D) model of a patient's teeth representing an initial setup state and receiving a target digital 3D model representing a final setup state;
forming a graph comprising vertices representing setup states and edges representing transitions between setup states, the graph comprising at least a vertex for the initial setup state and a vertex for the final setup state, the vertex for the initial setup state and the vertex for the final setup state being connected by an edge;
determining, by one or more processors, a candidate path through the graph between the initial setup state and the final setup state;
performing multi-resolution trajectory refinement on the candidate path by iterating over a plurality of step sizes, and for each step size:
(i) adjusting a resolution of the candidate path to the step size by interpolating intermediate setup states along the candidate path and updating the graph with the interpolated intermediate setup states;
(ii) evaluating setup states along the candidate path using an evaluation function based on collisions between tooth surface meshes;
(iii) while the candidate path fails to satisfy the evaluation function at the step size, identifying a refinement region along the candidate path, refining the graph in a neighborhood of the refinement region by adding additional setup states, recomputing a shortest path through the refined graph, and smoothing the recomputed shortest path by adding edges to the graph between setup states that satisfy the evaluation function at the step size; and
outputting a refined path of setup states as a sequence of orthodontic digital setups in a format compatible with fabrication of orthodontic appliances.

30. The method of claim 29, wherein the evaluation function is based on at least one of a number of collision contact points between triangular meshes representing tooth surfaces, or penetration depth between triangular meshes representing tooth surfaces.

31. The method of claim 30, wherein a setup state is treated as valid when the setup state has zero collision contact points.

32. The method of claim 29, wherein adjusting the resolution comprises removing an edge between successive setup states in the graph and adding the interpolated intermediate setup states and corresponding edges to the graph.

33. The method of claim 29, wherein interpolating is performed according to a same-finish policy in which all teeth complete prescribed motion at a last stage of the interpolated intermediate setup states.

34. The method of claim 29, wherein identifying the refinement region comprises returning all locations along the candidate path where a score computed using the evaluation function exceeds a threshold score.

35. The method of claim 29, wherein refining the graph comprises:
selecting a candidate vertex in the refinement region,
generating a perturbed setup state from the candidate vertex,
interpolating between the candidate vertex and the perturbed setup state at the step size to form an interpolated sequence, and
adding a valid subset of the interpolated sequence that satisfies the evaluation function to the graph.

36. The method of claim 29, wherein selecting the candidate vertex comprises, for a first iteration, selecting a worst-scoring candidate vertex according to a collision-based heuristic and, for subsequent iterations, selecting a candidate vertex randomly.

37. The method of claim 29, wherein smoothing comprises constructing candidate edges between setup states that are within a distance threshold and retaining a candidate edge when an interpolated path along the candidate edge satisfies the evaluation function at the step size.

38. The method of claim 29, further comprising staging the refined path to enforce per-stage tooth movement limits by selecting setup states from the refined path such that changes in tooth position and/or orientation between successive selected setup states do not exceed per-stage limits.

39. The method of claim 29, wherein the plurality of resolutions begins at a low resolution and subsequently moves to higher resolutions.

40. The method of claim 39, wherein the highest resolution is determined based on one or more tooth movement limits.

41. The method of claim 29, wherein the graph is initialized using at least one key intermediate setup state between the initial setup state and the final setup state.

42. The method of claim 29, further comprising using one or more heuristics to choose which vertex in a plurality of vertices to use as a candidate vertex in expanding the graph.

43. The method of claim 29, further comprising, using one or more heuristics to choose the manner in which the graph is to be expanded.

44. An orthodontic digital setup generation system comprising:
one or more processors;
one or more memories storing instructions that, when executed by the one or more processors, cause the system to:
receive an initial digital three-dimensional (3D) model of a patient's teeth representing an initial setup state and a target digital 3D model representing a final setup state;
form a graph comprising vertices representing setup states and edges representing transitions between setup states, the graph comprising at least a vertex for the initial setup state and a vertex for the final setup state, the vertex for the initial setup state and the vertex for the final setup state being connected by an edge;
determine a candidate path through the graph between the initial setup state and the final setup state;
perform multi-resolution trajectory refinement on the candidate path by iterating over a plurality of step sizes, and for each step size:
(i) adjust a resolution of the candidate path to the step size by interpolating intermediate setup states along the candidate path and updating the graph with the interpolated intermediate setup states;
(ii) evaluate setup states along the candidate path using an evaluation function based on collisions between tooth surface meshes; and
(iii) while the candidate path fails to satisfy the evaluation function at the step size, identify a refinement region along the candidate path, refining the graph in a neighborhood of the refinement region by adding additional setup states, recomputing a shortest path through the refined graph, and smoothing the recomputed shortest path by adding edges to the graph between setup states that satisfy the evaluation function at the step size; and
output a refined path of setup states as a sequence of orthodontic digital setups in a format compatible with fabrication of orthodontic appliances.

45. The system of claim 44, wherein the evaluation function is based on at least one of a number of collision contact points between triangular meshes representing tooth surfaces, or penetration depth between triangular meshes representing tooth surfaces.

46. The system of claim 45, wherein a setup state is treated as valid when the setup state has zero collision contact points.

47. The system of claim 44, wherein adjusting the resolution comprises removing an edge between successive setup states in the graph and adding the interpolated intermediate setup states and corresponding edges to the graph.

48. The system of claim 44, wherein interpolating is performed according to a same-finish policy in which all teeth complete prescribed motion at a last stage of the interpolated intermediate setup states.
